(19) United States
(12) Patent Application Publication
(10) Pub. No.: US 2026/0210307 A1
(43) Pub. Date: Jul. 23, 2026

(54) A SYSTEM FOR MITIGATING KNOCKING IN AN ENGINE AND A METHOD THEREOF

(71) Applicant: Mahindra and Mahindra Limited, Chengalpattu (IN)

(72) Inventors: Satish Kumar SIVARAJU, Chengalpattu (IN); Easwar Ram SREEDHAR, Chengalpattu (IN); Karthi RAMANATHAN, Chengalpattu (IN); Muthu RAMAKRISHNAN, Chengalpattu (IN); Navaneetha Kannan RAVINDRAN, Chengalpattu (IN); Vivekanand VEERAMANI, Chengalpattu (IN)

(73) Assignee: Mahindra and Mahindra Limited, Chengalpattu, TN (IN)

(21) Appl. No.: 19/143,979

(22) PCT Filed: Sep. 26, 2024
(86) PCT No.: PCT/IB2024/059406

§ 371 Date: Jun. 27, 2025

(30) Foreign Application Priority Data
Nov. 1, 2023 (IN) 202341074590

(51) Int. Cl. F02D 35/02; F02D 41/14; F02D 41/38; F02D 43/04

(52) U.S. Cl. CPC F02D 35/027; F02D 41/1406; F02D 41/38; F02D 43/04

(57) ABSTRACT

The present disclosure relates to engines. The present disclosure envisages a system for mitigating knocking having a fuel injection unit configured to be operable between a base injection mode and a knock resistant mode. The system comprises at least one sensing unit configured to sense vibrations of the engine, and a control unit configured to receive the intensity of vibrations to generate a first actuating signal. A first actuator receives the first actuating signal to alter the ignition angle and reduce the vibrations of the engine. The control unit generate a second actuating signal, which is received by a second actuator which engages the fuel injection unit in the knock resistant mode upon generation of the second actuating signal to mitigate engine knocking upon evaluation of at least one critical parameter.

### FIELD

The present disclosure relates to engines, more specifically to mechanisms for mitigating knocking in engines.

### Definition

As used in the present disclosure, the following terms are generally intended to have the meaning as set forth below, except to the extent that the context in which they are used indicates otherwise.

RESEARCH OCTANE NUMBER (RON): The term “research octane number (ron)” indicates the combustibility of engine fuel at low speeds and temperatures. RON reflects the behaviour of fuel under idling conditions and during acceleration. The higher the RON rating, the more compression it can withstand in a spark-ignition engine before igniting and resist knocking.

### BACKGROUND

The background information herein below relates to the present disclosure but is not necessarily prior art.

Detection of the knocking phenomenon of a combustion engine and controlling it are important for the smooth operation of the engine. Conventionally, the engine is equipped with sensors configured to detect vibrations experienced by the engine. The vibrations are interpreted as change in voltage signal i.e., voltage spikes which are directly proportional to the knocking phenomenon. A typical control measure involves retarding the ignition angle of the ignition unit. As per norms, the value at which the ignition angle is to be retarded is calibrated at manufacturing stage, and actively adapted by the vehicle engine management system for concurrent engine operating conditions i.e., speed and load. Retarding the ignition angle causes reduction in the peak operating pressure and operating temperature of the engine in order to mitigate knocking. Simultaneously, retardation of the ignition angle causes reduction in torque because the combustion event is delayed. This results in incomplete combustion (resulting in bad combustion quality) and much of the thermal energy from the fuel combustion is wasted, thus reducing the thermal efficiency. As a consequence of the above phenomena, the engine takes a longer time to recover from knocking to its optimum settings

Other conventional methods considered for reducing knock employ fuel injection with the support of a pair of injectors per cylinder or use of dual fuel techniques that supply secondary fuel/anti-knock liquid along with the primary fuel to suppress the in-cylinder knocking tendency. However, neither of these methods overcome the deficiency of the above mentioned conventional measure.

There is therefore felt a need for a system that alleviates the aforementioned drawbacks.

### OBJECTS

Some of the objects of the present disclosure, which at least one embodiment herein satisfies, are as follows:

An object of the present disclosure is to provide a system for mitigating knocking in an engine.

Another object of the present disclosure is to provide a system that mitigates loss of torque of an engine.

Yet another object of the present disclosure is to provide a system that reduces loss of thermal efficiency of an engine.

Still another object of the present disclosure is to provide a system that enhances the life an engine.

Yet another object of the present disclosure is to provide a system that dynamically adjust ignition timing in real-time to optimize combustion efficiency while minimizing knock occurrence.

Other objects and advantages of the present disclosure will be more apparent from the following description, which is not intended to limit the scope of the present disclosure.

### SUMMARY

The present disclosure envisages a system for mitigating knocking in an engine.

The engine is connected to an input unit configured to receive an input corresponding to a desired engine output and generate an input signal. The engine has a fuel injection unit and an ignition unit. The fuel injection unit is configured to be operable between a base injection mode and a knock resistant mode. The ignition unit is configured to be actuated at a predetermined ignition angle corresponding to the input signal. The system comprises at least one sensing unit, a first actuator, and a control unit.

The sensing unit is configured to be mounted on the engine. The sensing unit is configured to sense vibrations of the engine in an operative configuration thereof, and is further configured to generate a corresponding first sensed signal data.

The control unit is configured to communicate with the sensing unit to receive the first sensed signal data. The control unit is configured to generate a first actuating signal corresponding to the first sensed signal data.

The first actuator is configured to be in communication with the control unit to receive the first actuating signal. The first actuator is configured to alter the ignition angle from the predetermined ignition angle in reference to the first actuating signal to facilitate reduction in the vibrations of the engine.

The system is characterized by a feedback loop, where the sensing unit is further configured to sense vibrations after the alter of the ignition angle and generate a second sensed signal data corresponding to the the modified vibration characteristics. The control unit is further configured to receive the second sensed signal data to generate a second actuating signal if the second sensed signal data is more than a predetermined threshold value.

In an embodiment, the system may not generate second actuating signal if the first actuator is successfully reducing the vibrations of the engine.

Further, the system comprises a second actuator configured to be connected to the control unit to receive the second actuating signal data. The second actuator is configured to engage the fuel injection unit in the knock resistant mode upon generation of the second actuating signal to thereby the system dynamically controls the engine parameters to minimize the knocking and optimize the engine performance.

In an embodiment, the second actuator is configured to engage the fuel injection unit in the base injection mode if the second sensed signal data falls below the predetermined threshold value.

In an embodiment, the control unit includes a processor which includes:
a regulator configured to identify reception of the sensed signal even after actuation of the first actuator, and is further configured to generate a ticket;
a computing unit coupled to the regulator, and the crawler-and-extractor unit to receive the extracted values, the computing unit is configured to calculate an instantaneous value of all three critical parameters simultaneously on the basis of the first actuating signal upon receipt of the ticket; and
at least one comparator coupled to the computing unit and is configured to receive the computed value, the comparator is configured to compare the computed value with the predetermined threshold value, and further configured to generate the second actuating signal if the computed value exceeds or is equal to its corresponding predetermined threshold value.

In an embodiment, the critical parameters are at least one selected from the group consisting of low RON factor, instantaneous ignition retard and average filtered ignition retard, or a combination thereof.

Further, the present invention also envisages a turbocharged direct injection spark ignition engine connected to an input unit configured to receive an input corresponding to a desired engine output and generate an input signal. The engine has a fuel injection unit and an ignition unit, the fuel injection unit being configured to be operable between the base injection mode and the knock resistant mode. The ignition unit being configured to be actuated at a predetermined ignition angle corresponding to the input signal. The system comprises the sensing unit mounted on the engine, the sensing unit is configured to sense the intensity of vibrations of the engine in an operative configuration thereof, and further configured to generate a first sensed signal data; the control unit is configured to communicate with the sensing unit to receive the sensed signal data to generate a first actuating signal; and the first actuator connected to the control unit to receive the first actuating signal, the first actuator configured to alter the ignition angle from the predetermined ignition angle in reference to the first actuating signal to facilitate reduction in the vibrations of the engine; wherein the control unit is further configured to generate the second actuating signal.

In an embodiment, the system further comprises the second actuator configured to be connected to the control unit to receive the second actuating signal, the second actuator configured to engage the fuel injection unit in the knock resistant mode upon generation of the second actuating signal to mitigate engine knocking.

Further, the present also envisages a method for mitigating knocking in an internal combustion engine wherein the engine is connected to an input unit configured to receive an input corresponding to a desired engine output and generate an input signal, the engine having a fuel injection unit and an ignition unit, the fuel injection unit being configured to be operable between a base injection mode and a knock resistant mode, and the ignition unit being configured to be actuated at a predetermined ignition angle corresponding to the input signal. The method comprises the following steps:
detecting engine vibrations indicative of knocking using at least one sensing unit, wherein the sensing unit generating the first sensed signal data representing the intensity and frequency of the vibrations;
transmitting the first sensed signal data to the control unit, wherein the control unit configured to generate the first actuation signal corresponding to the first sensed signal data;
altering the ignition angle from the predetermined ignition angle to a modified ignition angle using the first actuator in response to the first actuation signal to reduce knocking-induced vibrations;
sensing vibrations after adjusting the ignition angle using the sensing unit in a feedback loop, and generating the second sensed signal data representing the modified vibration characteristics;
transmitting the second sensed signal data to the control unit;
generating the second actuation signal if the second sensed signal data exceeds a predefined threshold value; and
engaging the fuel injection unit in a knock-resistant mode using the second actuator in response to the second actuation signal for dynamically controlling the engine parameters for minimizing the knocking and optimizing the engine performance.

### BRIEF DESCRIPTION OF THE ACCOMPANYING DRAWING

A system and a method, of the present disclosure, for mitigating knocking in an engine will now be described with the help of the accompanying drawing, in which:

FIG. 1 illustrates a block chart of the system of the present disclosure.

FIG. 2 illustrates a flow chart of the critical parameter check condition in accordance with the present disclosure.

### LIST OF REFERENCE NUMERALS

100 system
102 sensing unit
106 control unit
108 repository
109 processor
110 crawler-and-extractor unit
111 regulator
112 computing unit
114 comparator
116 first actuator
118 second actuator

### DETAILED DESCRIPTION

Embodiments, of the present disclosure, will now be described with reference to the accompanying drawing.

Embodiments are provided so as to thoroughly and fully convey the scope of the present disclosure to the person skilled in the art. Numerous details are set forth, relating to specific components, and methods, to provide a complete understanding of embodiments of the present disclosure. It will be apparent to the person skilled in the art that the details provided in the embodiments should not be construed to limit the scope of the present disclosure. In some embodiments, well-known processes, well-known apparatus structures, and well-known techniques are not described in detail.

The terminology used, in the present disclosure, is only for the purpose of explaining a particular embodiment and such terminology shall not be considered to limit the scope of the present disclosure. As used in the present disclosure, the forms “a”, “an” and “the” may be intended to include the plural forms as well, unless the context clearly suggests otherwise. The terms “comprises”, “comprising”, “including”, “includes” and “having” are open-ended transitional phrases and therefore specify the presence of stated features, elements, modules, units and/or components, but do not forbid the presence or addition of one or more other features, elements, components, and/or groups thereof.

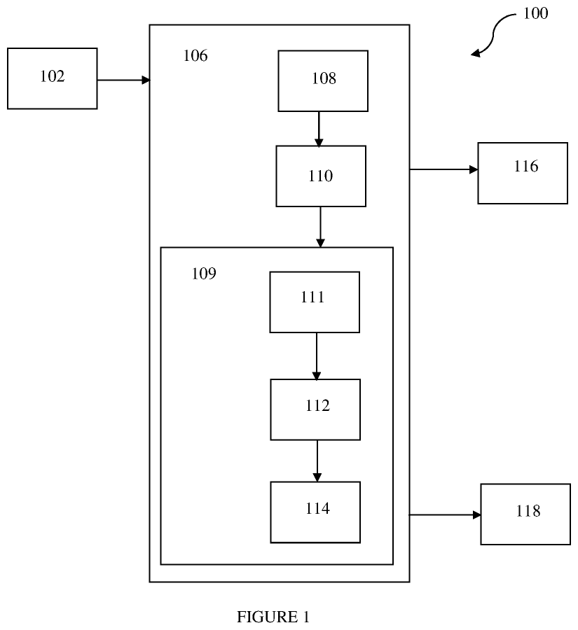

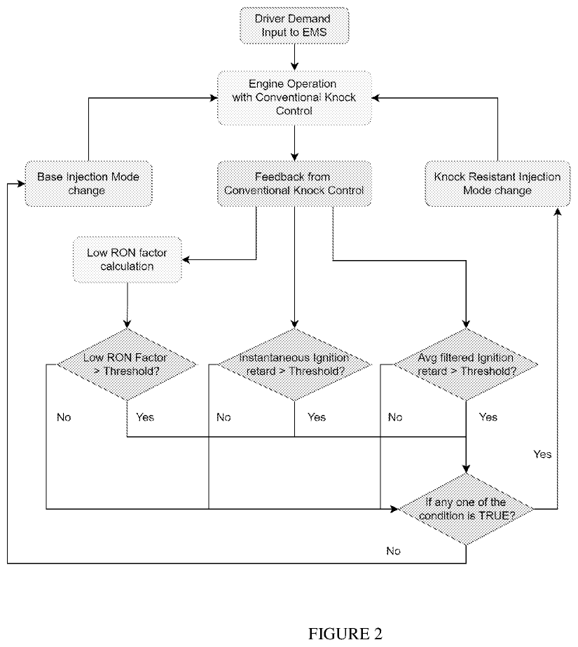

A system (100), of the present disclosure, for mitigating knocking in an engine will now be described in detail with reference to FIG. 1 and FIG. 2.

The engine is connected to an input unit configured to receive an input corresponding to a desired engine output and generate an input signal. The engine has a fuel injection unit and an ignition unit. The fuel injection unit is configured to be operable between a base injection mode and a knock resistant mode. The ignition unit is configured to be actuated at a predetermined ignition angle corresponding to the input signal. The system comprises at least one sensing unit (102), a first actuator (116), and a control unit (106).

The sensing unit (102) is configured to be mounted on the engine. The sensing unit (102) is configured to sense vibrations of the engine in an operative configuration thereof, and is further configured to generate a corresponding first sensed signal.

The control unit (106) is configured to communicate with the sensing unit (102) to receive the first sensed signal and convert said first sensed signal to a first sensed signal data. The control unit (106) is configured to generate a first actuating signal corresponding to the first sensed signal data.

The first actuator (116) is configured to be connected to the control unit (106) to receive the first actuating signal. The first actuator (116) is configured to alter the ignition angle from the predetermined ignition angle in reference to the first actuating signal to facilitate reduction in the vibrations of the engine.

In an embodiment, the first actuator (116) is configured to retard or advance the ignition angle from the predetermined ignition angle, specifically with respect to top dead centre of the engine, which in turn reduces the peak operating pressure and operating temperature of the engine thereby, enabling mitigation of the vibrations.

In a preferred embodiment, the retardation in the ignition angle continues till no more vibrations are detected by the sensing unit (102). In such an instance where vibrations cease to exist, the first actuator (116) is configured to advance the ignition angle and equalize it with the predetermined ignition angle. While the equalization of the ignition angle is enabled, the sensing unit (102) continues to sense any gradual increase in vibrations on the engine.

The system is configured with a feedback loop. The feedback loop enables the system to further reduce the vibrations to mitigate the knocking in the engine. Therefore, the feedback loop facilitates the sensing unit to sense further sense vibrations after the alter of the ignition angle and generate a second sensed signal data corresponding to the modified vibration characteristics. The control unit (106) is further configured to generate a second actuating signal if the second sensed signal data is more than a predetermined threshold value.

In an embodiment, if the first actuator is successfully reducing the vibrations of the engine, the second actuation signal may not be generated by the control unit.

Further, the system (100) comprises a second actuator (118) configured to be connected to the control unit (106) to receive the second actuating signal. The second actuator (118) is configured to engage the fuel injection unit in the knock resistant mode upon generation of the second actuating signal to thereby the system (100) dynamically controls the engine parameters to minimize the knocking and optimize the engine performance. On the other hand, the second actuator (118) is configured to engage the fuel injection unit in the base injection mode if the second sensed data falls below the predetermined threshold value.

The base injection mode is a single injection strategy which induces an injection pulse only during the induction stroke. On the other hand, the knock resistant mode involves a double injection strategy which induces a first injection during the induction stoke and a second injection pulse late into the compression stroke. Splitting the fuel injection event by including more than one pulse change aids in suppressing the knocking during combustion as more number of injections helps in changing the in-cylinder dynamics of the engine. Therefore, to enable the knock resistant mode, the second actuator (118) changes the number of injections while switching from the base injection mode to the knock resistant injection mode.

In an embodiment, the second sensed signal data will be generated by the controller regardless of the success of the first actuator signal. However, the system may switch on the second actuating signal based on satisfaction of at least one critical parameter check condition. The critical parameter check condition is illustrated through a flow chart in the FIG. 2. The critical parameters check condition includes: i) Is low RON factor greater than threshold value? ii) Is instantaneous ignition retard greater than threshold value? and iii) Is average ignition retard greater than threshold value? Therefore, if any one of the above said critical parameter evaluates as TRUE i.e. more than the set threshold, then the second actuating signal facilitates change in the injection mode from the base injection mode to the knock resistance injection mode. Further, if all the critical parameters are evaluated as FALSE, the mode is changed back to original.

The first immediate reaction however, remains with the first actuating signal, which reacts when the first sensed signal data of the engine vibrations are higher than a predefined threshold.

In an embodiment, the control unit (106) includes a repository (108) configured to store therewithin a list of values of deviation of the ignition angle corresponding to different values of desired engine outputs. The repository (108) is further configured to store a predetermined threshold value corresponding to at least one critical parameter.

In an embodiment, the control unit (106) includes a converter configured to convert the sensed signal to the sensed data. In another embodiment, the control unit (106) includes a crawler-and-extractor unit (110) configured to receive the sensed signal. The crawler-and-extractor unit (110) is configured to crawl through the stored list to extract a value of deviation of the ignition angle based on the received input signal, and is further configured to generate a first actuating signal.

In yet another embodiment, the first actuator (116) is configured to retard the ignition angle from the predetermined ignition angle by a value of deviation based on the actuating signal.

In an embodiment, the control unit (106) includes a processor (109) including a regulator (111), a computing unit (112) coupled to the regulator (111) and to the crawler-and-extractor unit (110), and at least one comparator (114) coupled to the computing unit (112). The regulator (111) is configured to identify reception of the sensed signal even after actuation of the first actuator, and is further configured to generate a ticket. The computing unit (112) is configured to receive the extracted values and the ticket, and is further configured to calculate instantaneous values of the at least one critical parameter upon receipt of the ticket. The comparator (114) is configured to compare the computed value with the predetermined threshold value, and is further configured to generate a second actuating signal if the computed value exceeds or is equal to its corresponding stored value.

In an embodiment, the critical parameters are at least one selected from the group consisting of low RON factor, instantaneous ignition retard and average filtered ignition retard, or a combination thereof. In another embodiment, even if one of the above mentioned parameters exceed their threshold values, the knock resistant injection mode will be engaged till such a condition is no longer satisfied.

In an embodiment, if all the critical parameters are evaluated as FALSE. i.e. all the values of the critical parameters become less than the threshold value, the comparator (114) is configured to generate a third actuating signal. The second actuator is configured to receive the third actuating signal to disengage the knock resistant injection mode and engage the base injection mode.

The present disclosure further envisages a turbocharged direct injection spark ignition engine (hereinafter referred as turbocharged engine).

The engine is connected to an input unit configured to receive an input corresponding to a desired engine output and generate an input signal. The turbocharged engine has a fuel injection unit and an ignition unit. The fuel injection unit is configured to be operable between a base injection mode and a knock resistant mode. The ignition unit is configured to be actuated at a predetermined ignition angle corresponding to the input signal. The turbocharged engine is provided with a system (100) for mitigating knocking. The system comprises at least one sensing unit (102), a first actuator (116), and a control unit (106). The sensing unit (102) is configured to be mounted on the turbocharged engine. The sensing unit (102) is configured to sense vibrations of the turbocharged engine in an operative configuration thereof, and is further configured to generate a first sensed signal.

The control unit (106) is configured to communicate with the sensing unit to receive the first sensed signal and convert the first sensed signal to a first sensed signal data. The control unit (106) is configured to generate a first actuating signal corresponding to the first sensed signal data.

The first actuator (116) is configured to be connected to the control unit (106) to receive the first actuating signal. The first actuator (116) is configured to alter the ignition angle from the predetermined ignition angle to facilitate reduction in the vibrations of the engine.

The system is configured with a feedback loop. The feedback loop enables the system to further reduce the vibrations to mitigate the knocking in the turbocharged engine. Therefore, the feedback loop facilitates the sensing unit to sense further sense vibrations after the alter of the ignition angle and generate a second sensed signal data corresponding to the the modified vibration characteristics. The control unit (106) is further configured to generate a second actuating signal if the second sensed signal data is more than a predetermined threshold value. In an embodiment, if the first actuator is successfully reducing the vibrations of the engine, the second actuation signal may not be generated by the control unit.

Further, the system (100) comprises a second actuator (118) configured to be connected to the control unit (106) to receive the second actuating signal. The second actuator (118) is configured to engage the fuel injection unit in the knock resistant mode upon generation of the second actuating signal thereby the system (100) dynamically controls the engine parameters to minimize the knocking and optimize the engine performance. On the other hand, the second actuator (118) is configured to engage the fuel injection unit in the base injection mode if the second sensed data falls below the predetermined threshold value.

The system (100), of the present disclosure, helps in maintaining the performance and thermal efficiency of the engine in addition to protecting the engine from knock caused by low quality fuel. More specifically, the system (100) ensures that changeover between the operating modes suppresses the knocking phenomenon whilst allowing the engine to retrieve the torque and efficiency reduced during the initial deviation of the ignition angle. The improvement factor observed for torque with respect to speed is provided below in Table 1.

TABLE 1

| | Torque Achieved (Nm) | | |
|---|---|---|---|
| | | Torque obtained | |
| | | by system (100) | Thermal Efficiency (%) |
| | Torque obtained | which induces | Average estimated loss |
| | by conventional | double injection | in thermal efficiency by |
| | system of | pulse (i.e., by | staying in the base |
| | inducing single | inducing base | injection mode and not |
| En- | injection pulse | injection mode | using knock resistant |
| gine | (i.e., by inducing | and knock | injection mode (Base |
| Speed | only base | resistant injection | mode is equivalent to |
| (RPM) | injection mode) | mode) | single injection mode) |
| 1000 | x-5 | x | 1.0 |
| 1250 | x-25 | x | 4.0 |
| 1500 | x-45 | x | 5.0 |
| 1750 | x-10 | x | 1.3 |
| 2000 | x-5 | x | 0.7 |

The torque obtained (as shown in Table 1) is observed for a fuel with the highest known knocking tendency i.e., fuel of Research Octane number (RON) 91 or less.

The foregoing description of the embodiments has been provided for purposes of illustration and not intended to limit the scope of the present disclosure. Individual components of a particular embodiment are generally not limited to that particular embodiment, but, are interchangeable. Such variations are not to be regarded as a departure from the present disclosure, and all such modifications are considered to be within the scope of the present disclosure.

### TECHNICAL ADVANCEMENTS

The present disclosure described hereinabove has several technical advantages including, but not limited to, the realization of a system for mitigating knocking in an engine and a method thereof, which:
enables the engine to recover relatively faster from the knocking phenomena to its optimum settings;
mitigates loss of torque of the engine;
relatively decreases loss of thermal efficiency of the engine; and
enhances the life of the engine.

The foregoing disclosure has been described with reference to the accompanying embodiments which do not limit the scope and ambit of the disclosure. The description provided is purely by way of example and illustration.

The embodiments herein and the various features and advantageous details thereof are explained with reference to the non-limiting embodiments in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

Any discussion of materials, devices, articles or the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

The numerical values mentioned for the various physical parameters, dimensions or quantities are only approximations and it is envisaged that the values higher/lower than the numerical values assigned to the parameters, dimensions or quantities fall within the scope of the disclosure, unless there is a statement in the specification specific to the contrary.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

1. A system (100) for mitigating knocking in an engine, wherein said engine is connected to an input unit configured to receive an input corresponding to a desired engine output and generate an input signal, said engine having a fuel injection unit and an ignition unit, said fuel injection unit being configured to be operable between a base injection mode and a knock resistant mode, and said ignition unit being configured to be actuated at a predetermined ignition angle corresponding to the input signal, said system (100) comprising:
at least one sensing unit (102) mounted on the engine, said sensing unit (102) configured to sense the intensity of vibrations of the engine in an operative configuration thereof, and further configured to generate a corresponding first sensed signal data;
a control unit (106) configured to communicate with said sensing unit to receive said first sensed signal data, said control unit (106) configured to generate a first actuating signal corresponding to said first sensed signal data; and
a first actuator (116) configured to be in communication with said control unit (106) to receive said first actuating signal, said first actuator (106) configured to alter the ignition angle from the predetermined ignition angle in reference to said first actuating signal to facilitate reduction in the vibrations of the engine,
wherein said system is characterized by:
a feedback loop wherein said sensing unit (102) is further configured to sense vibrations after the alter of said ignition angle and generate a second sensed signal data corresponding to the the modified vibration characteristics, said control unit (106) is further configured to receive said second sensed signal data to generate a second actuating signal if said second sensed signal data is more than a predetermined threshold value; and
a second actuator (118) configured to be connected to said control unit (106) to receive said second actuating signal, said second actuator (118) configured to engage the fuel injection unit in the knock resistant mode upon generation of said second actuating signal to thereby said system (100) dynamically controls the engine parameters to minimize the knocking and optimize the engine performance.

2. The system (100) as claimed in claim 1, wherein said second actuator (118) is configured to engage the fuel injection unit in the base injection mode if said second sensed data falls below the predetermined threshold value.

3. The system (100) as claimed in claim 1, wherein said control unit (106) includes a repository (108) configured to store therewithin a list of values of deviation of the ignition angle corresponding to different values of desired engine outputs, and a predetermined threshold value corresponding to at least one critical parameter.

4. The system (100) as claimed in claim 3, wherein said control unit (106) includes a converter configured to convert said sensed signal to said sensed signal data.

5. The system (100) as claimed in claim 4, wherein said control unit (106) includes a crawler-and-extractor unit (110) configured to receive said sensed data, said crawler-and-extractor unit (110) configured to crawl through said stored list to extract a value of deviation of the ignition angle based on said received input signal, and further configured to generate a first actuating signal.

6. The system (100) as claimed in claim 5, wherein said first actuator (116) is configured to retard or advance the ignition angle from the predetermined ignition angle by a value of deviation based on said actuating signal.

7. The system (100) as claimed in claim 6, wherein said control unit (106) includes a processor (109) including:
a regulator (111) configured to identify reception of said sensed signal even after actuation of said first actuator, and further configured to generate a ticket;
a computing unit (112) coupled to said regulator (111), and said crawler-and-extractor unit (110) to receive said extracted values, said computing unit (112) configured to calculate an instantaneous value of all three critical parameters simultaneously on the basis of said first actuating signal upon receipt of said ticket; and
at least one comparator (114) coupled to said computing unit (112) configured to receive the computed value, the comparator (114) configured to compare said computed value with said predetermined threshold value, and further configured to generate said second actuating signal if said computed value exceeds or is equal to its corresponding predetermined threshold value.

8. The system (100) as claimed in claim 7, wherein said critical parameters are at least one selected from the group consisting of Low RON factor, instantaneous ignition retard and average filtered ignition retard, or a combination thereof.

9. A turbocharged direct injection spark ignition engine connected to an input unit configured to receive an input corresponding to a desired engine output and generate an input signal, said turbocharged engine having a fuel injection unit and an ignition unit, said fuel injection unit being configured to be operable between a base injection mode and a knock resistant mode, and said ignition unit being configured to be actuated at a predetermined ignition angle corresponding to the input signal, said turbocharged engine having a system (100) for mitigating knocking in said turbocharged engine, said system (100) comprising:
at least one sensing unit (102) mounted on the engine, said sensing unit (102) configured to sense the intensity of vibrations of the engine in an operative configuration thereof, and further configured to generate a first sensed signal data;
a control unit (106) configured to communicate with said sensing unit (102) to receive said first sensed signal data, said control unit (106) configured to generate a first actuating signal corresponding to said first sensed signal data; and
a first actuator (116) configured to be in communication with said control unit (106) to receive said first actuating signal, said first actuator (106) configured to alter the ignition angle from the predetermined ignition angle in reference to said first actuating signal to facilitate reduction in the vibrations of the engine,
wherein said system (100) is characterized by:
a feedback loop wherein said sensing unit (102) is further configured to sense vibrations after the alter of said ignition angle and generate a second sensed signal value corresponding to the the modified vibration characteristics, said control unit (106) is further configured to receive said second sensed signal value to generate a second actuating signal if said second sensed data is more than a predetermined threshold value; and
a second actuator (118) configured to be connected to said control unit (106) to receive said second actuating signal, said second actuator (118) configured to engage the fuel injection unit in the knock resistant mode upon generation of said second actuating signal to mitigate engine knocking.

10. A method for mitigating knocking in an internal combustion engine, wherein said engine is connected to an input unit configured to receive an input corresponding to a desired engine output and generate an input signal, said engine having a fuel injection unit and an ignition unit, said fuel injection unit being configured to be operable between a base injection mode and a knock resistant mode, and said ignition unit being configured to be actuated at a predetermined ignition angle corresponding to the input signal, said method comprising the following steps:
detecting engine vibrations indicative of knocking using at least one sensing unit (102), wherein said sensing unit (102) generating a first sensed signal data representing the intensity and frequency of the vibrations;
transmitting said first sensed signal data to a control unit (106), wherein said control unit (106) configured to generate a first actuation signal corresponding to said first sensed signal data;
altering the ignition angle from the predetermined ignition angle to a modified ignition angle using a first actuator (116) in response to said first actuation signal to reduce knocking-induced vibrations;
sensing vibrations after adjusting the ignition angle using said sensing unit (102) in a feedback loop, and generating a second sensed signal data representing the modified vibration characteristics;
transmitting said second sensed signal data to said control unit (106);
generating a second actuation signal if said second sensed signal data exceeds a predefined threshold value; and
engaging the fuel injection unit in a knock-resistant mode using a second actuator (118) in response to said second actuation signal for dynamically controlling the engine parameters for minimizing the knocking and optimizing the engine performance.
